(19) United States
(12) Patent Application Publication
(10) Pub. No.: US 2004/0064340 A1
(43) Pub. Date: Apr. 1, 2004

(54) System and method for performing a legal audit

(76) Inventor: J. Phillips L. Johnston, High Point, NC (US)

Correspondence Address: JINAN GLASGOW, P O BOX 28539, RALEIGH, NC, 276118539

(21) Appl. No.: 10/672,502

(22) Filed: Sep. 26, 2003

Related U.S. Application Data
(60) Provisional application No. 60/415,228, filed on Oct. 1, 2002.

(51) Int. Cl. G06F 17/60

(52) U.S. Cl. 705/1

(57) ABSTRACT

A system and method for performing legal audits of corporate records and legal documents to identify areas of potential litigation for a company in advance of the commencement of actual litigation or other legal dispute.

### CROSS-REFERENCE TO RELATED APPLICATIONS

This non-provisional utility patent application claims the benefit of one or more prior filed copending applications, a reference to each such prior application is identified as follows: this application is based upon and claims priority from the filing of provisional application No. 60/415228.

### BACKGROUND OF THE INVENTION

(1) Field of the Invention

The present invention relates generally to auditing systems and methods and, more particularly, to an auditing system and method for performing legal audits.

(2) Description of the Prior Art

Typically, companies are engaged in business transactions that may lead to litigation at some point in the future, either with suppliers, customers, competitors, or other third parties who may or may not have legitimate claims against the company. Corporate records and legal documents typically play an important role in any litigation; however, during the normal course of business, corporate officers, directors, and managers typically do not make a regular review of corporate records and legal documents in the context of the business to determine whether any reasonable potential for litigation exists. Instead, a company usually does not act until a dispute arises and/or litigation is threatened and/or actually undertaken by a claimant. Therefore, a need exists for an auditing system and method for performing and providing the framework for a regular review of corporate records and legal documents in the context of the business in order to analyze that information and for identifying potential areas of litigation in order to take preventive action and/or make a resolution of the issue to minimize and/or to avoid litigation and/or to reduce legal costs associated therewith.

While no prior art exists in the area of legal audit systems and/or methods, prior art auditing systems have existed for accounting and for intellectual property, which are merely small areas of most businesses that often do not have a high potential for litigation over the general and/or daily course of business of a company.

By way of example, prior art auditing systems for accounting and intellectual property are described in U.S. Pat. No. 6,263,314 issued Jul. 17, 2001 to Donner for Method of performing intellectual property audit optionally over network architecture and U.S. patent application publication No. US20020077941A1 published Jun. 20, 2002 for applicants Halligan, et al. for Method and apparatus for documentation, analysis, auditing, accounting, protection, registration, and verification of trade secrets; neither of these prior art auditing systems provide an integrated means for considering potential areas of litigation for a company in its normal course of business. While Halligan, et al. disclose a system that includes a legal reviewer, the legal reviewer does not provide for an overview of areas of potential litigation for the company.

Thus, there remains a need for an auditing system and method for performing legal audits to identify potential litigation and to reduce legal costs of companies.

### SUMMARY OF THE INVENTION

The present invention is directed to a system and method for performing legal audits to identify potential litigation in advance of the commencement of actual litigation or other legal dispute.

Accordingly, one aspect of the present invention is to provide a method according to the present invention including the steps of reviewing important legal documents relating to a company's business, including corporate documents such as bylaws and minutes of meetings for the board of directors and other corporate officers, summarizing legal documents in business terms readily understandable by corporate officers and directors, overseeing the organization of all important legal documents, and advising the board of directors and corporate officers of select issues, matters, and areas of potential litigation, thereby providing the company advance notice in order to take action(s) to minimize and/or avoid litigation and to reduce legal costs for the company. Legal documentation includes, but is not limited to, intellectual property documentation.

Another aspect of the present invention is to provide a system according to the present invention for performing the method set forth hereinabove, including records of the company's business transactions, minutes of board of directors meetings, contractual agreements, licensing agreements, supplier and vendor agreements, purchase orders, partnership agreements, communications with competitors, intellectual property documents and registrations, and the like, a computer system and database of these records, automated categorization of the records in an index and/or a spreadsheet, wherein the index and/or the spreadsheet are searchable by an authorized user of the system.

These and other aspects of the present invention will become apparent to those skilled in the art after a reading of the following description of the preferred embodiment.

### DETAILED DESCRIPTION OF THE PREFERRED EMBODIMENTS

In the following description, it is to be understood that preferred embodiments according to the present invention are provided for the purpose of illustrating and disclosing the invention to one of ordinary skill in the art and to set forth the best mode known at the time of the invention; as such, the detailed description of preferred embodiments is not intended to limit the invention thereto, rather the invention is properly considered to include equivalents to those embodiments, as appropriate.

In a preferred embodiment of the present invention, a system is provided for performing the method set forth hereinabove, including records of the company's business transactions, minutes of board of directors meetings, contractual agreements, licensing agreements, supplier and vendor agreements, purchase orders, partnership agreements, communications with competitors, intellectual property documents and registrations, and the like, a computer system and database of these records, automated categorization of the records in an index and/or a spreadsheet, wherein the index and/or the spreadsheet are searchable by an authorized user of the system.

Also in a preferred embodiment of the present invention, a method is provided including the steps of reviewing important legal documents relating to a company's business, including corporate documents such as bylaws and minutes of meetings for the board of directors and other corporate officers and managers, summarizing legal documents in business terms readily understandable by corporate officers and directors, as well as managers, overseeing the organization of all important legal documents, and advising the board of directors and corporate officers and managers of select issues, matters, and areas of potential litigation, thereby providing the company advance notice in order to take action(s) to minimize and/or to avoid litigation and to reduce legal costs for the company.

This method is optionally implementable over a computer network, wherein a predetermined number of authorized users are permitted to have access to the system; in this case, an additional step of at least one authorized user logging into a computer network by entering a unique identifier, which may include a user name and password or other unique identifier, including but not limited to biometric identifiers. Furthermore, once the at least one authorized user is logged into the computer network for accessing records of the company's business transactions, minutes of board of directors meetings, contractual agreements, licensing agreements, supplier and vendor agreements, purchase orders, partnership agreements, communications with competitors, intellectual property documents and registrations, and the like, the user performs the steps set forth hereinabove, namely, reviewing important legal documents relating to a company's business, searching the computer system and database for relevant documents and records, analyzing the legal documents and corporate records located in the computer system and database by using an automated categorization of the records in an index and/or a spreadsheet, summarizing legal documents in business terms readily understandable by corporate officers, directors and managers, overseeing the organization of all important legal documents, and advising the board of directors, corporate officers, and managers of select issues, matters, and areas of potential litigation, for the purpose of providing the company advance notification of potential areas of litigation by citing specific, relevant documents, in order for the corporate officers, managers, and/or directors, as well as their legal advisors, either in-house or independent outside counsel, to take action(s) to minimize and/or avoid litigation and to reduce legal costs for the company.

The legal audit system and method according to the present invention preferably captures all legal documents electronically in layman terms for all managers, bankers, auditors, and combinations thereof and other users of the system.

Preferably, the legal audit system and method according to the present invention provides for the minutes, by-laws, articles of incorporation, all corporate agreements to be studied and reduced to summary form in business language. Additionally, potential legal landmines, i.e., issues that are identified as potential problems that might result in legal action being taken against the company, would be flagged by the system and method of the present invention so that an authorized user and/or the system operating under predetermined settings can then take appropriate compliance action such as to remove, delete, or otherwise purge from the system such documents or problems until the issue is resolved according to the rules or predetermined guidelines of the system or to the satisfaction of the authorized user(s) according to company policy. Preferably, the method provides for regular review of such documents and compliance action as set forth hereinabove is undertaken on a regular, predetermined basis, such as daily, weekly, monthly or quarterly, by way of example. Personnel practices are preferably included in a report, which may be automatically generated by the system based upon the predetermined rules, guidelines, and/or compliance procedures relevant to the company, to the full board of directors, especially those regarding how the company follows employee policies and how employees are treated, with particular emphasis on those of the opposite sex. Interviews with senior management about potential price fixing and similar issues would be addressed. Specifications, engineering claims, and sales brochures would be reviewed for veracity during the legal audit method.

By way of further example regarding compliance procedures, the legal audit system and method according to the present invention will ascertain if appropriate policies designed to result in compliance with applicable laws and regulations are in place. Then it is determined or identified by the system and method of the present invention if there are reasonable assurances that employees are informed of corporate policies directed at compliance with applicable laws, including (i) antidiscrimination and employment laws, (ii) environmental and health and safety laws, (iii) antitrust laws—even small companies are subject to antitrust laws and (iv) the securities laws, especially those that relate to offering company stock or debt to individuals. Since there should be appropriate procedures for monitoring compliance with such laws throughout the organization or company, the legal audit system and method according to the present invention will ensure that all persons involved in the compliance process have direct access to the general counsel or other compliance officer so that sensitive compliance situations may be raised for prompt consideration and disposition. Foreign Corrupt Practices Act of 1977 compliance, conflicts of interest, corporate opportunities, gifts from business associates, misuse of confidential information and political contributions will be reviewed.

A program of legal compliance that is well conceived and properly implemented can significantly reduce the incidence of violations of laws and corporate policy. It may also reduce or eliminate civil lawsuits, penalties or prosecution against the organization for those violations of law that occur in spite of such a program. Since the enactment of the United States Sentencing Commission's sentencing guidelines for organizations, corporations have been given further reason to review and reassess their compliance policies and procedures. These guidelines greatly increase the penalties for businesses found guilty of criminal violations, but provide significant fine reductions for convicted corporations that maintain appropriate programs to prevent and detect violations of law.

Furthermore, the legal audit system and method according to the present invention will ascertain if there is a functioning and effective system in place for approval of commitments of the corporation's financial and commercial resources. The legal auditor must be satisfied that a reasonable approval system exists, there is an understanding by management its authority and what action requires board approval. Additionally, it will ensure the adequacy of internal controls, such as those stressed by Sarbines-Oxley legislation in the US. Even though the act applies only to public companies, the standard of care for private companies has been raised to a much higher level. The legal audit system and method according to the present invention will ensure that the client/company has adequate internal controls, which are the primary defense against embezzlements. The protection of assets within the legal audit system and method according to the present invention considers whether there are procedures for protecting intellectual property and safeguarding confidential information. Insurance arrangements will be reviewed. Another outcome of the application of the legal audit system and method according to the present invention includes a substantially strengthened client relationship with emphasis on valuable legal service and achievement, not hours billed; if the legal audit is conducted for a prospective client, a new client can be expected as a direct result of the audit.

Certain modifications and improvements will occur to those skilled in the art upon a reading of the foregoing description. By way of example, the system and method may include a diagram or a multiplicity of diagrams that represents a summary of important matter, document, organizational structure, and the like. Also, certain legal documents that are amplified by other documents, such as by-laws, may be linked or connected with the corresponding amplifying documents. Future or new negotiations, which would create new legal documents, could be framed using existing legal documents, such as, by way of example and not limitation, licensing fields or other limitations for intellectual property, tracking. All modifications and improvements have been deleted herein for the sake of conciseness and readability but are properly within the scope of the following claims.

What is claimed is:

1. A system for providing automated legal audits of a business comprising a data processing system having at least one computer and user interface, with software running on the computer for providing at least one user with information relating to a legal audit, wherein said information is selected from the group consisting of records of the company's business transactions, minutes of board of directors meetings, contractual agreements, licensing agreements, supplier and vendor agreements, purchase orders, partnership agreements, communications with competitors, intellectual property documents and registrations, and combinations thereof, and wherein the data processing system further includes a database of these records having automated categorization of the records in an index and/or a spreadsheet, wherein the index and/or the spreadsheet are searchable by an authorized user of the system.

2. A method comprising the steps of
providing a system for providing automated legal audits of a business comprising a data processing system having at least one computer and user interface, with software running on the computer for providing at least one user with information relating to a legal audit, wherein said information is selected from the group consisting of records of the company's business transactions, minutes of board of directors meetings, contractual agreements, licensing agreements, supplier and vendor agreements, purchase orders, partnership agreements, communications with competitors, intellectual property documents and registrations, and combinations thereof, and wherein the data processing system further includes a database of these records having automated categorization of the records in an index and/or a spreadsheet, wherein the index and/or the spreadsheet are searchable by an authorized user of the system;
reviewing legal documents relating to a company's business, wherein said documents are contained in electronic format in the data processing system or database;
summarizing legal documents in business terms;
overseeing the organization of all important legal documents; and
advising the board of directors and corporate officers and managers, thereby providing the company advance notice in order to take action(s) to minimize and/or to avoid litigation and to reduce legal costs for the company.

3. The method according to claim 2, wherein the corporate documents include bylaws, minutes of meetings for the board of directors, other corporate officers, and/or managers.

4. The method according to claim 2, wherein the business terms are readily understandable by corporate officers, directors, and managers.

5. The method according to claim 2, wherein the advising step includes advising regarding select issues, matters, and areas of potential litigation.
